(19) United States
(12) Patent Application Publication
(10) Pub. No.: US 2020/0202017 A1
(43) Pub. Date: Jun. 25, 2020

(54) SECURE COMMUNICATION FOR LOG REPORTING IN MEMORY SUB-SYSTEMS

(71) Applicant: Micron Technology, Inc., Boise, ID (US)

(72) Inventors: Jonathan Parry, Boise, ID (US); Qing Liang, Boise, ID (US); Giuseppe Cariello, Boise, ID (US); Robert W. Strong, Folsom, CA (US); James Ruane, San Jose, CA (US)

(21) Appl. No.: 16/228,203

(22) Filed: Dec. 20, 2018

(51) Int. Cl. G06F 21/60; H04L 9/08; H04L 9/30

(52) U.S. Cl. CPC G06F 21/606; G06F 21/602; H04L 9/30; H04L 9/0894; H04L 9/0869; H04L 9/0822

(57) ABSTRACT

A request for memory sub-system log data is received from a host system. In response to receiving the request, a symmetric encryption key for encrypting the requested memory-sub-system log data is generated. The requested memory sub-system log data is encrypted using the symmetric encryption key. The symmetric encryption key is encrypted using an asymmetric encryption key. An encrypted data payload is generated and sent to the host system in response to the request. The encrypted data payload comprises the encrypted encryption key and the encrypted memory sub-system log data.

### TECHNICAL FIELD

Embodiments of the disclosure relate generally to memory sub-systems, and more specifically, relate to a secure communication for log reporting in memory sub-systems.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some embodiments of the present disclosure.

FIG. 2 is a data flow diagram illustrating interactions between components in a secure communication environment in performing an example method for memory sub-system log reporting, in accordance with some embodiments of the present disclosure.

FIG. 3 is a swim lane diagram illustrating interactions between components in the secure communication environment in performing an example method for memory sub-system log reporting, in accordance with some embodiments of the present disclosure.

FIGS. 4 and 5 are flow diagrams illustrating an example method for memory sub-system log reporting using secure communication techniques, in accordance with some embodiments of the present disclosure.

FIG. 6 is a block diagram of an example computer system in which embodiments of the present disclosure may operate.

### DETAILED DESCRIPTION

Aspects of the present disclosure are directed to class-based dynamic memory slot allocation in a memory sub-system. A memory sub-system is also hereinafter referred to as a “memory device.” An example of a memory sub-system is a storage system, such as a SSD. In some embodiments, the memory sub-system is a hybrid memory/storage sub-system. In general, a host system can utilize a memory sub-system that includes one or more memory components. The host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory sub-system may store confidential, proprietary, or other sensitive information that should only be accessed by specifically authorized users such as field engineers. As an example of such information, a memory sub-system may maintain and store a debug log that includes information regarding operation of the memory sub-system that may be used to diagnose and correct problems occurring on the memory sub-system. Typically, this type of information needs to be communicated to an external computing machine (e.g., server) operated by authorized personnel who utilize the debug log to perform failure analysis and debugging. With conventional memory sub-systems, both the retrieval of the information from the memory sub-system and communication of the information to the external computing machine are vulnerable to snooping because of a lack of security protocols. The security vulnerabilities of conventional memory sub-systems are likely to result in unauthorized access of debug logs including any confidential, proprietary, or other sensitive information included therein. Some conventional memory sub-systems attempt to obfuscate debug log data, but merely obfuscating the debug log data typically does not prevent unauthorized access.

Aspects of the present disclosure address the above and other deficiencies by implementing a security protocol in communications of debug log data by a memory sub-system controller. The security protocol includes generating an asymmetric key pair comprising a public key and a private key, provisioning a memory sub-system controller with the public key to encrypt sensitive information, and provisioning a secure server with the private key to decrypt the sensitive information. A host system may request debug log data (also referred to herein as “memory sub-system log data” or simply as “log data”) from the memory sub-system, and the memory sub-system responds with an encrypted data payload comprising the requested debug log data. A security component of the memory sub-system uses the public key to generate the encrypted data payload, and since the host system does not have the private key, the host system is unable to access the requested debug log data, which may include confidential, proprietary, or other sensitive information. Instead, the host system forwards the encrypted data payload to the secure server, and the secure server may, in turn, decrypt the encrypted data payload using the private key.

In some embodiments, the security component of the memory sub-system generates a symmetric key in response to receiving the debug log data request from the host system and uses the symmetric key to encrypt the requested debug log data. The security component encrypts the symmetric key using the public asymmetric encryption key and generates the encrypted data payload by combining the encrypted debug log data and the encrypted encryption key. By preparing the encrypted data payload in this manner, the security component leverages the capabilities of symmetric encryption algorithms to encrypt large chunks of sensitive information, while also leveraging the additional security of asymmetric encryption techniques to protect the symmetric encryption key, which limits the access of the raw sensitive information to the secure server. Upon receiving the encrypted data payload, the secure server uses the private asymmetric encryption key to decrypt the encrypted symmetric encryption key and uses the decrypted symmetric encryption key to decrypt the encrypted debug data log.

In some embodiments, if a size of the requested debug log data does not satisfy a threshold size condition (e.g., if the size is less than or equal to a size of the asymmetric encryption key), then the security component may forego generating the symmetric encryption key and instead encrypt the requested data using the public asymmetric key. Consistent with these embodiments, the encrypted data payload comprises only the encrypted log data and the secure server may decrypt the encrypted log data using the private key. If the size of the requested debug log data satisfies the threshold size condition (e.g., if the size exceeds the size of the asymmetric encryption key), the security component prepares the encrypted data payload using a combination of symmetric and asymmetric encryption in the manner discussed above. By employing different encryption techniques depending on the size of the debug log data, the security component can optimize overall encryption speed by avoiding performance of slower symmetric encryption techniques on small chunks of sensitive information that do not require multiple encryption cycles using asymmetric techniques, while utilizing symmetric encryption to encrypt large amounts of log data that would be too large for asymmetric encryption techniques to handle in a single cycle.

Utilizing the security protocol described above reduces vulnerabilities in the communication of sensitive information that is present in conventional memory sub-systems by preventing access of sensitive information by unauthorized parties because, at worst, only the encrypted data, rather than the raw data, may be accessed via snooping. The security protocol also provides the advantage of a uniform protocol to support secure communication of log data across all end-users. Additionally, the security protocol provides a secure mechanism for end-users to provide data logs to authorized personnel without having to provide end-users with encryption keys, which would likely lead to increased security vulnerabilities.

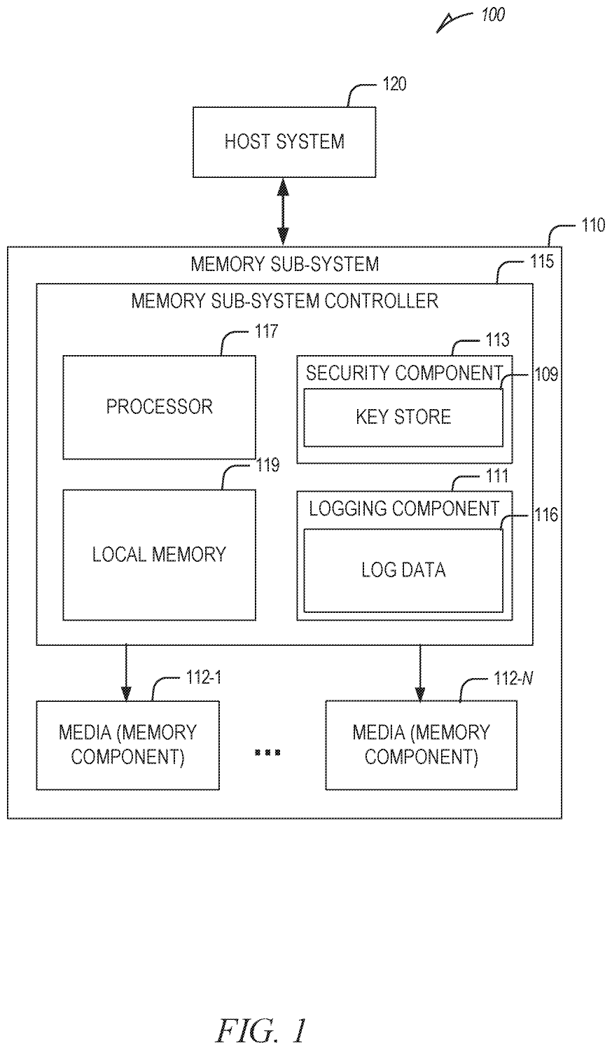

FIG. 1 illustrates an example computing environment 100 that includes a memory sub-system 110, in accordance with some embodiments of the present disclosure. The memory sub-system 110 can include media, such as memory components 112-1 to 112-N. The memory components 112-1 to 112-N can be volatile memory components, non-volatile memory components, or a combination of such. In some embodiments, the memory sub-system 110 is a storage system. An example of a storage system is a SSD. In some embodiments, the memory sub-system 110 is a hybrid memory/storage sub-system. In general, the computing environment 100 can include a host system 120 that uses the memory sub-system 110. For example, the host system 120 can write data to the memory sub-system 110 and read data from the memory sub-system 110.

The host system 120 can be a computing device such as a desktop computer, laptop computer, network server, mobile device, or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. As used herein, “coupled to” generally refers to a connection between components, which can be an indirect communicative connection or direct communicative connection (e.g., without intervening components), whether wired or wireless, including connections such as electrical, optical, magnetic, and the like. Examples of a physical host interface include, but are not limited to, a serial advanced technology attachment (SATA) interface, a peripheral component interconnect express (PCIe) interface, a universal serial bus (USB) interface, a Fibre Channel interface, a Serial Attached SCSI (SAS), and so forth. The physical host interface can be used to transmit data between the host system 120 and the memory sub-system 110. The host system 120 can further utilize an NVM Express (NVMe) interface to access the memory components 112-1 to 112-N when the memory sub-system 110 is coupled with the host system 120 by the PCIe interface. The physical host interface can provide an interface for passing control, address, data, and other signals between the memory sub-system 110 and the host system 120.

The memory components 112-1 to 112-N can include any combination of the different types of non-volatile memory components and/or volatile memory components. An example of non-volatile memory components includes a negative- and (NAND)-type flash memory. Each of the memory components 112-1 to 112-N can include one or more arrays of memory cells such as single-level cells (SLCs) or multi-level cells (MLCs) (e.g., triple-level cells (TLCs) or quad-level cells (QLCs)). In some embodiments, a particular memory component can include both an SLC portion and an MLC portion of memory cells. Each of the memory cells can store one or more bits of data (e.g., data blocks) used by the host system 120. Although non-volatile memory components such as NAND-type flash memory are described, the memory components 112-1 to 112-N can be based on any other type of memory such as a volatile memory. In some embodiments, the memory components 112-1 to 112-N can be, but are not limited to, random access memory (RAM), read-only memory (ROM), dynamic random access memory (DRAM), synchronous dynamic random access memory (SDRAM), phase change memory (PCM), magneto random access memory (MRAM), negative-or (NOR) flash memory, electrically erasable programmable read-only memory (EEPROM), and a cross-point array of non-volatile memory cells. A cross-point array of non-volatile memory cells can perform bit storage based on a change of bulk resistance in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, as noted above, the memory cells of the memory components 112-1 to 112-N can be grouped as data blocks that can refer to a unit of the memory component used to store data.

A memory sub-system controller 115 (hereinafter referred to as a “controller”) can communicate with the memory components 112-1 to 112-N to perform operations such as reading data, writing data, or erasing data at the memory components 112-1 to 112-N and other such operations. The controller 115 can include hardware such as one or more integrated circuits and/or discrete components, a buffer memory, or a combination thereof. The controller 115 can be a microcontroller, special-purpose logic circuitry (e.g., a field programmable gate array (FPGA), an application specific integrated circuit (ASIC), etc.), or other suitable processor. The controller 115 can include a processor (processing device) 117 configured to execute instructions stored in local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, etc. The local memory 119 can also include ROM for storing micro-code. While the example memory sub-system 110 in FIG. 1 has been illustrated as including the controller 115, in another embodiment of the present disclosure, a memory sub-system 110 may not include a controller 115, and may instead rely upon external control (e.g., provided by an external host, or by a processor or controller separate from the memory sub-system).

In general, the controller 115 can receive commands or operations from the host system 120 and can convert the commands or operations into instructions or appropriate commands to achieve the desired access to the memory components 112-1 to 112-N. The controller 115 can be responsible for other operations such as wear leveling operations, garbage collection operations, error detection and error-correcting code (ECC) operations, encryption operations, caching operations, and address translations between a logical block address and a physical block address that are associated with the memory components 112-1 to 112-N. The controller 115 can further include host interface circuitry to communicate with the host system 120 via the physical host interface. The host interface circuitry can convert the commands received from the host system into command instructions to access the memory components 112-1 to 112-N as well as convert responses associated with the memory components 112-1 to 112-N into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory components 112-1 to 112-N.

The memory sub-system 110 includes a logging component 111 to monitor operation of the memory sub-system 110 and collect log data 116 based thereon. The log data 116 comprises statistical information that describes the operation of the memory sub-system over a period of time. This information may be used (e.g., by a field application engineer (FAE)) to debug the memory sub-system 110. Hence, those of ordinary skill in the art may recognize the log data 116 as corresponding to a memory sub-system “debug log.” The log data 116 may, for example, include: a read/write histogram; a valid logic block addressing count; a cumulative count of asynchronous power cycles; a cumulative count of total bytes written to the memory sub-system 110 by the host system 120; bit error count histograms for each logical unit number; error recovery statistics; a cumulative count of firmware background/foreground tasks; an aggregated write-read temperature; power-on hours; highest/lowest temperature of the memory sub-system 110; and a number of host interface errors. In some embodiments, the log data 116 is stored within a local memory of the memory sub-system controller 115 (e.g., local memory 119). In some embodiments, the log data 116 is stored within one or more of the memory components 112-1 to 112-N.

The memory sub-system 110 also includes a security component 113 that facilitates secure communication between the controller 115 and the host system 120. The security component 113 may be included in the controller 115 or any one or more of the memory components 112-1 to 112-N. In some embodiments, the controller 115 includes at least a portion of the security component 113. For example, the controller 115 can include a processor 117 (processing device) configured to execute instructions stored in local memory 119 for performing the operations described herein. In some embodiments, the security component 113 is part of the host system 120, an application, or an operating system.

The security component 113 receives requests for log data 116 or a portion thereof from the host system 120 and provides the host system 120 with an encrypted data payload in response thereto. The encrypted data payload includes encrypted log data that corresponds to the requested log data. The security component 113 may further include a key store 109 to store one or more encryption keys used by the security component 113 to encrypt sensitive information. In some embodiments, the key store 109 is implemented within a local memory of the memory sub-system controller 115 (e.g., local memory 119). In some embodiments, the key store 109 is implemented within one or more of the memory components 112-1 to 112-N.

The security component 113 may communicate with the host system 120 via the host interface or a native sideband communication port (e.g., a Universal Asynchronous Receiver/Transmitter (U ART) port or other serial communication port that supports two-way communication) that may be specially configured as a diagnostic or maintenance port.

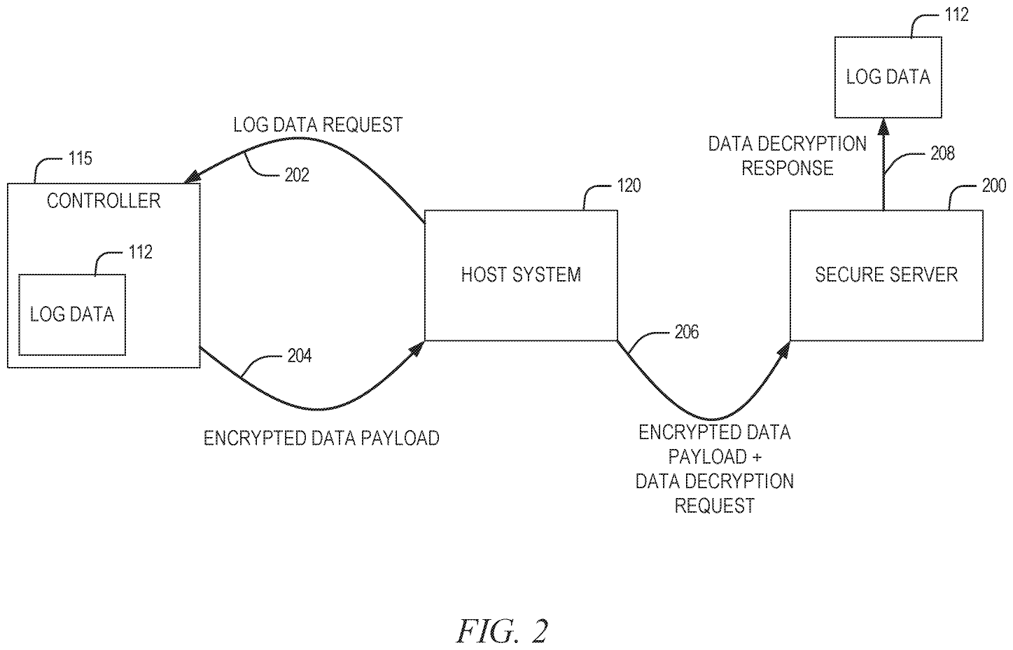

FIG. 2 is a data flow diagram illustrating interactions between components in a secure communication environment in performing an example method for memory sub-system log reporting, in accordance with some embodiments of the present disclosure. In the context of FIG. 2, an asymmetric encryption key pair—a public key and a private key—may be pre-generated, and the security component 113 may be provisioned with the public key to encrypt data, while a secure server 200 is provisioned with the private key to decrypt the data. The security component 113 stores the public key in the key store 109.

As shown, at 202, the host system 120 sends a request for memory sub-system log data 116 to the controller 115. In response to the request, the security component 113 of the controller 115 encrypts the requested log data 116 and generates an encrypted data payload that includes the encrypted log data. In some embodiments, the security component 113 may generate and use a symmetric encryption key to encrypt the requested log data 116. Consistent with these embodiments, security component 113 may encrypt the symmetric encryption key with an asymmetric encryption key and generate the encrypted data payload by combining the encrypted encryption key with the encrypted log data 116. In other embodiments, the security component 113 may simply use the asymmetric encryption key to encrypt the requested log data 116 and generate the encrypted data payload that includes only the encrypted log data 116.

At 204, the controller 115 responds to the request from the host system 120 with the encrypted data payload, and a user of the host system 120 (e.g., a FAE) in turn provides the encrypted data payload along with a data decryption request to a secure server 200 (at 206) capable of decrypting the decrypted data payload. The secure server 200, in turn, decrypts the encrypted data payload and at 208, the secure server 200 provides the raw decrypted log data 116 in response to the data decryption request.

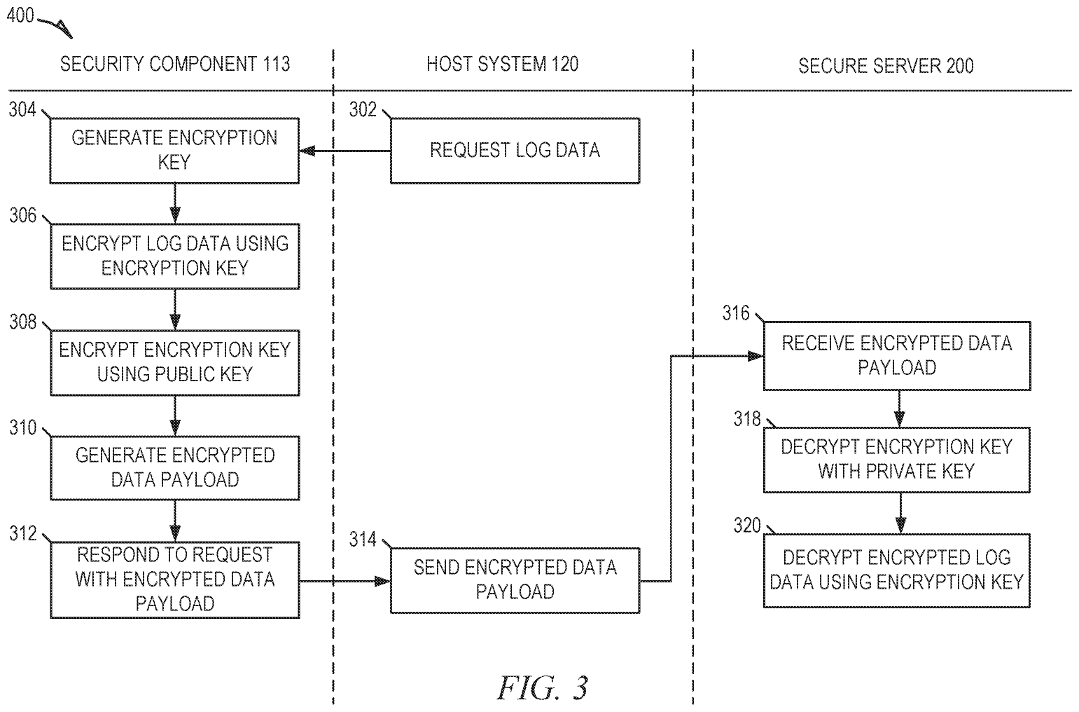

FIG. 3 is a swim lane diagram illustrating interactions between components in the secure communication environment in performing an example method 300 for memory sub-system log reporting, in accordance with some embodiments of the present disclosure. As shown, the method 300 begins at operation 302 where the host system 120 sends a request for memory sub-system log data to the security component 113 of the controller 115. In response to receiving the request, the security component 113 generates, at operation 304, an encryption key (e.g., a symmetric encryption key in accordance with the Advanced Encryption Standard (AES)) for encrypting the requested memory sub-system log data.

At operation 306, the security component 113 encrypts the requested log data using the encryption key. In encrypting the requested log data, the security component 113 generates encrypted log data. At operation 308, the security component 113 encrypts the encryption key with a public encryption key (e.g., generated as part of a key pair using the Rivest-Shamir-Adleman (RSA) algorithm). In encrypting the encryption key, the security component 113 generates an encrypted encryption key. At operation 310, the security component 113 generates an encrypted data payload by combining the encrypted log data and the encrypted encryption key. The security component 114 responds to the request from the host system 120, at operation 312, with the encrypted data payload.

The host system 120 is not provisioned with a corresponding private encryption key, and thus, the host system 120 is unable to decrypt the encrypted data payload. Accordingly, upon receiving the encrypted data payload, the host system 120 or a user of the host system 120 (e.g., a FAE) sends the encrypted data payload to the secure server 200 as part of a decryption request at operation 314.

The secure server 200 maintains the private encryption key corresponding to the public encryption key used to encrypt the symmetric encryption key. Thus, the secure server 200 is capable of decrypting the encrypted data payload data. Accordingly, upon receiving the encrypted data payload (at operation 316), the secure server 200 decrypts the encrypted symmetric encryption key, at operation 318, using the private encryption key. Upon decrypting the symmetric encryption key, the secure server 200 decrypts the encrypted log data using the symmetric encryption key (operation 320). A FAE or other personnel may then use the log data to debug the memory sub-system 110.

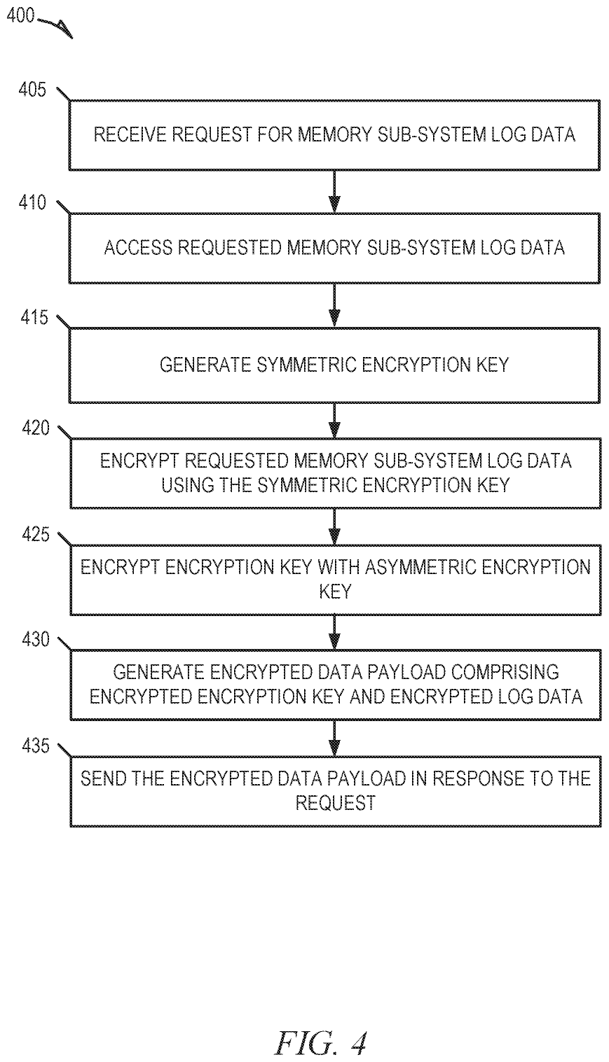

FIG. 4 is a flow diagram illustrating an example method 400 to optimize burst write operations in a memory sub-system, in accordance with some embodiments of the present disclosure. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 400 is performed by the security component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device receives a request for memory sub-system log data. The request may be received from a host system (e.g., host system 120). The log data comprises statistical information regarding operation of a memory sub-system (e.g., memory sub-system 110) that may, for example, be used to debug the memory sub-system. A logger component of the memory sub-system (e.g., the logger component 111) monitors operation of the memory sub-system and generates the log data. The log data may be stored in a local memory of a memory sub-system controller (e.g., controller 115). In some embodiments, receiving the request includes receiving one or more commands from the host system via a host system interface. In some embodiments, receiving the request includes receiving the request from the host system via a communication port (e.g., a UART port or other serial communication port that supports two-way communication). The communication port may be a native port specifically configured for diagnostic or maintenance purposes.

At operation 410, the processing device accesses the requested memory sub-system log data. For example, the processing device may access the requested memory sub-system log data from a local memory of the memory sub-system controller 115 or from any one of the memory components 112-1 to 112-N.

At operation 415, the processing device generates a symmetric encryption key for encrypting the requested memory sub-system log data. The generating of the symmetric encryption key may comprise generating a random or pseudo-random number using a random number generator such as a deterministic random bit generator (DRBG). The generating of the symmetric encryption key may further comprise deriving the symmetric encryption key from the random or pseudo-random number using a key derivation function (KDF). Consistent with some embodiments, the processing device generates the symmetric encryption key according to the AES. For example, the processing device may generate a 256 byte AES encryption key.

At operation 420, the processing device encrypts the requested memory sub-system log data using the symmetric encryption key. The encrypting of the requested memory sub-system log data results in encrypted memory sub-system log data.

At operation 425, the processing device encrypts the symmetric encryption key with an asymmetric encryption key. The encrypting of the symmetric encryption key produces an encrypted encryption key. The asymmetric encryption key is previously allocated to the processing device (e.g., by the secure server 200) and may be stored in a key store implemented in a memory of the processing device (e.g., key store 109 of the security component 113). The asymmetric encryption key corresponds to a public key of an asymmetric key pair. A private key of the asymmetric key pair may be maintained in a secure environment such a secure server (e.g., the secure server 200) configured to process decryption requests with respect to encrypted memory sub-system log data. Consistent with some embodiments, the asymmetric key pair is previously generated (e.g., by secure server 200) using an RSA algorithm.

In some embodiments, the processing device may utilize a pre-post processing scheme in encrypting the symmetric encryption key. For example, the processing device may perform optimal asymmetric encryption padding (OAEP) whereby the processing device pads the symmetric encryption key with one or more additional bits to conform to a size of the asymmetric encryption key.

At operation 430, the processing device generates an encrypted data payload comprising the encrypted memory sub-system log data and the encrypted encryption key. At operation 435, the processing device sends the encrypted data payload to the host system in response to the request. As discussed above, the host system may send the encrypted payload data to an external server that is capable of decrypting the encrypted data payload. For example, the server may maintain a private key that can be used to decrypt the encrypted encryption key, and the server may then use the decrypted symmetric encryption key to decrypt the encrypted memory sub-system log data.

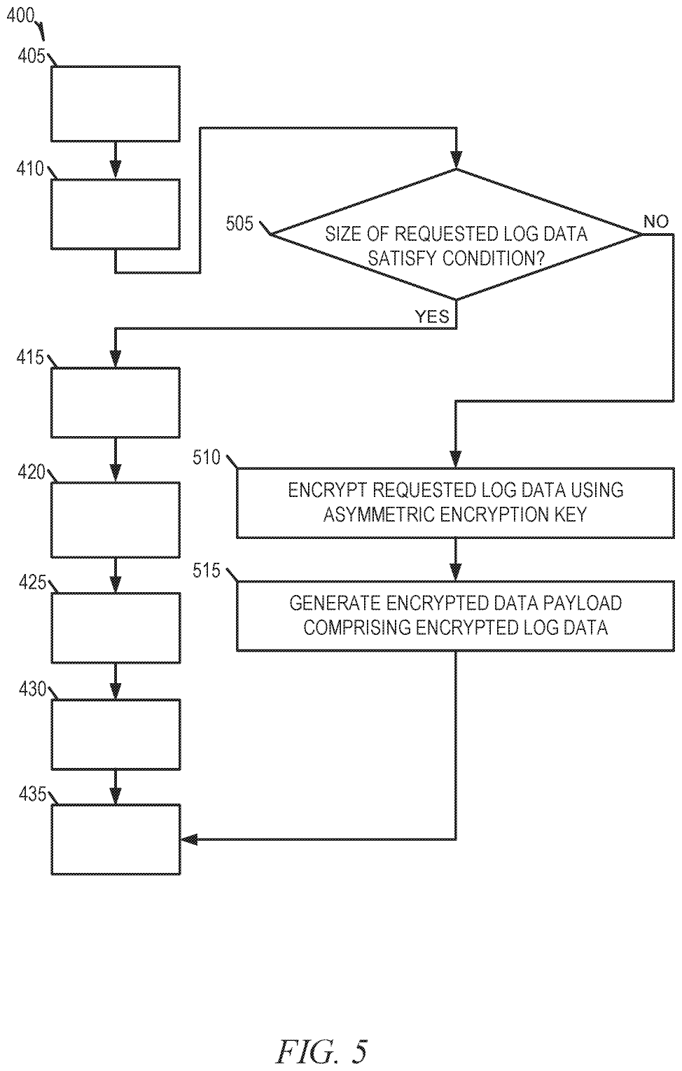

As shown in FIG. 5, the method 400 may, in some embodiments, include operations 505, 510, and 515. Consistent with these embodiments, operation 505 may be performed prior to operation 415 where the processing device generates a symmetric encryption key. At operation 505, the processing device determines whether a size of the requested memory sub-system log data satisfies a threshold size condition (e.g., based on whether the size exceeds a size of the asymmetric encryption key). As an example, in embodiments in which RSA encryption is utilized, the threshold size condition may establish a threshold size at 2048 bits, which is the size of encryption keys generated using the RSA encryption algorithm.

If the size of the requested memory sub-system log data satisfies the threshold size condition, the method 400 proceeds to operation 415 where the processing device generates a symmetric encryption key. By performing symmetric encryption on the requested memory sub-system log data when it is too large (e.g., when it satisfies the threshold size condition), the processing device avoids performing multiple encryption cycles that would be necessitated if asymmetric encryption were used, thereby resulting in an improvement to encryption speed and an optimization to the speed at which the processing device may respond to the request.

On the other hand, if the size of the requested memory sub-system log data does not satisfy the threshold size condition (e.g., the size does not exceed the size of the asymmetric encryption key), the method 400 proceeds to operation 510 where the processing device encrypts the requested memory sub-system log data using the asymmetric encryption key (e.g., the public key). By performing asymmetric encryption on the requested memory sub-system log data when it is small enough to be handled quickly by asymmetric encryption (e.g., when it does not satisfy the threshold size condition), the processing device avoids performing both asymmetric (e.g., on the symmetric encryption key) and symmetric encryption (e.g., on the memory sub-system log data), thereby optimizing the speed by which the processing device may respond to the request.

If the size of the requested memory sub-system log data does not satisfy the threshold size condition (e.g., because the size is less than the size of the asymmetric key), the processing device may perform one or more pre-processing operations on the memory sub-system log data to prepare it for asymmetric encryption. As an example, the processing device may perform OAEP with respect to the requested memory sub-system log data whereby the processing device pads the requested memory sub-system log data with additional bytes prior to encryption. That is, the processing device may append additional bytes (e.g., of value “0”) to the requested memory sub-system log data prior to encryption.

At operation 515, the processing device generates an encrypted data payload comprising the encrypted memory sub-system log data (i.e., the memory sub-system log data encrypted using the asymmetric encryption key). As shown, the method 400 continues to operation 435 where the processing device sends the encrypted data payload to the host system in response to the request. In comparison with the encrypted data payload generated at operation 430, the encrypted data payload generated at operation 515 does not include an encrypted encryption key and the memory sub-system log data is encrypted using the asymmetric encryption key rather than the symmetric encryption key. Accordingly, a secure server provisioned with the corresponding private encryption key can decrypt the encrypted data payload generated at operation 515 without first decrypting an encryption key.

### EXAMPLES

Example 1 is a system comprising: a memory component, and a processing device, operatively coupled with the memory component, to perform operations comprising: receiving, from a host system, a request for memory sub-system log data; in response to receiving the request, generating a symmetric encryption key for encrypting the requested memory-sub-system log data; encrypting the requested memory sub-system log data using the symmetric encryption key, the encrypting of the requested memory sub-system producing encrypted memory sub-system log data; encrypting the symmetric encryption key using an asymmetric encryption key, the encrypting of the symmetric encryption key producing an encrypted encryption key; generating an encrypted data payload comprising the encrypted encryption key and the encrypted memory sub-system log data; and sending the encrypted data payload to the host system in response to the request received from the host system.

In Example 2, the subject matter of Example 1 optionally comprises a two-way communication port, wherein the request is received via the communication port of the processing device.

In Example 3, the subject matter of Examples 1 or 2 optionally comprises a host interface to facilitate communication between the processing device and the host system, wherein the request corresponds to one or more commands received from the host system via the host interface.

In Example 4, the subject matter of any one of the Examples 1-3 optionally comprises a key store to store the asymmetric encryption key.

In Example 5, the subject matter of any one of Examples 1-4 optionally further comprises a logging component to generate and store the log data.

In Example 6, the memory sub-system log data of any one of Examples 1-5 optionally comprises statistical information related to operation of a memory sub-system.

In Example 7, the subject matter of any one of Examples 1-6 optionally comprises generating the symmetric encryption key based on the AES.

In Example 8, the generating of the symmetric encryption key in any one of the Examples 1-7 optionally comprises: generating, by a random number generator, a random number, and deriving the symmetric encryption key from the random number using a key derivation function.

In Example 9, the subject matter of any one of Examples 1-8 optionally comprises generating the asymmetric encryption key using an RSA encryption algorithm.

In Example 10, the subject matter of any one of Examples 1-9 optionally comprises an encryption key pair comprising a public key and a private key, wherein the asymmetric encryption key corresponds to the public key.

In Example 11, the subject matter of any one of Examples 1-10 optionally comprises providing, by the host system, the encrypted data payload to a secure server, wherein the secure server is configured to decrypt the encrypted symmetric encryption key using the private key; and decrypt the encrypted log data using the encryption key.

Example 12 is a method comprising: receiving, from a host system, a request for memory sub-system log data; in response to receiving the request, generating, by at least one processor of a memory sub-system controller, a symmetric encryption key for encrypting the requested memory-sub-system log data; encrypting, by the at least one processor of the memory sub-system controller, the requested memory sub-system log data using the symmetric encryption key, the encrypting of the requested memory sub-system producing encrypted memory sub-system log data; encrypting, by the at least one processor of the memory sub-system controller, the symmetric encryption key using an asymmetric encryption key, the encrypting of the symmetric encryption key producing an encrypted encryption key; generating, by the at least one processor of the memory sub-system controller, an encrypted data payload comprising the encrypted encryption key and the encrypted memory sub-system log data; and sending the encrypted data payload to the host system in response to the request received from the host system.

In Example 13, the subject matter of Example 12 optionally comprises receiving the request from the host system via a communication port of the memory sub-system controller.

In Example 14, the subject matter of any one of Examples 12 or 13 optionally comprises receiving one or more commands received from the host system via a host interface of the memory sub-system controller, wherein the one or more commands correspond to the request.

In Example 15, the subject matter of any one of Examples 12-14 optionally comprises accessing the requested memory sub-system log data from a logger component of the memory sub-system controller, the memory sub-system log data comprising statistical information related to operation of a memory sub-system.

In Example 16, the subject matter of any one of Examples 12-15 optionally comprises: generating the encryption key based on the AES; and generating the asymmetric encryption key using an RSA encryption algorithm.

In Example 17, the subject matter of any one of Examples 12-16 optionally comprises: generating, by a random number generator, a random number; and deriving the symmetric encryption key from the random number using a key derivation function.

In Example 18, the subject matter of any one of Examples 12-17 optionally comprises: sending the encrypted data payload to a secure server, the secure server having a private key corresponding to the asymmetric encryption key; decrypting, at the secure server, the encrypted encryption key using the private key, the decrypting of the encrypted encryption key producing the symmetric encryption key; and decrypting the encrypted log data using the symmetric encryption key.

Example 19 is a non-transitory computer-readable storage medium comprising instructions that, when executed by a processing device, configures the processing device to perform operations comprising: receiving, from a host system, a request for memory sub-system log data; determining whether a size of the requested memory sub-system log data satisfies a threshold size condition; based on determining the size of the requested memory sub-system log data satisfies the threshold size condition, generating a symmetric encryption key for encrypting the requested memory-sub-system log data; encrypting the requested memory sub-system log data using the symmetric encryption key, the encrypting of the requested memory sub-system producing encrypted memory sub-system log data; encrypting the symmetric encryption key using an asymmetric encryption key, the encrypting of the encryption key producing an encrypted encryption key; generating an encrypted data payload comprising the encrypted encryption key and the encrypted memory sub-system log data; and sending the encrypted data payload to the host system in response to the request received from the host system.

In example 20, the subject matter of Example 19 optionally further comprises configuring the processing device to perform further operations comprising: configuring the processing device to perform operations: encrypting the requested memory sub-system using the asymmetric encryption key based on determining the size of the requested memory sub-system log data does not satisfy the threshold size condition; and sending a response to the request to the host system, the response including the encrypted memory sub-system.

### Machine Architecture

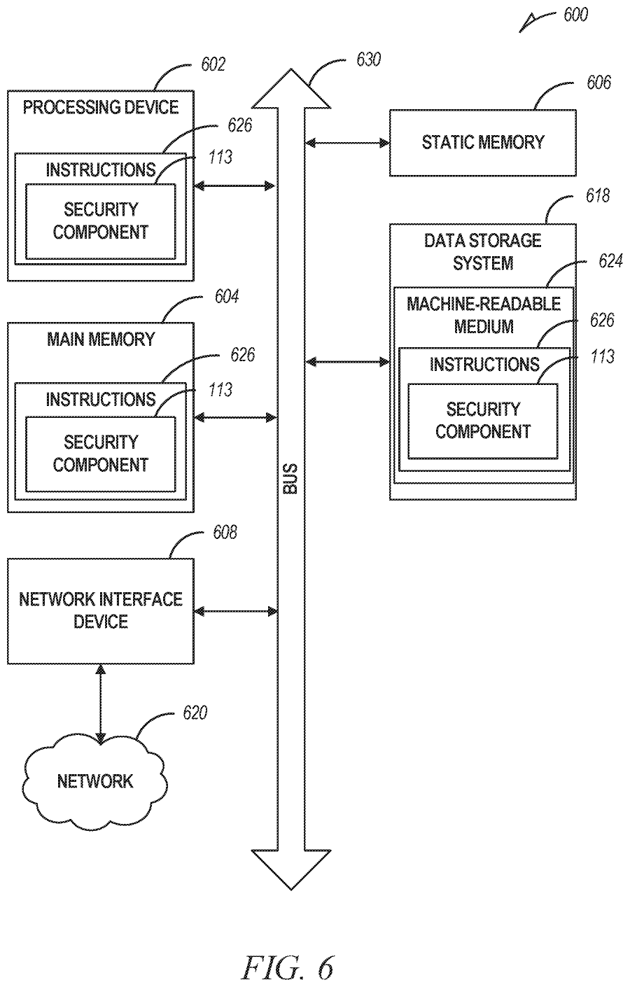

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the security component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an ASIC, a FPGA, a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a memory allocation system (e.g., the security component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; ROMs; RAMs; erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., a computer-readable) storage medium such as a ROM, a RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory component; and
a processing device, operatively coupled with the memory component, to perform operations comprising:
receiving, from a host system, a request for memory sub-system log data;
in response to receiving the request, generating a symmetric encryption key for encrypting the requested memory-sub-system log data;
encrypting the requested memory sub-system log data using the symmetric encryption key, the encrypting of the requested memory sub-system producing encrypted memory sub-system log data;
encrypting the symmetric encryption key using an asymmetric encryption key, the encrypting of the symmetric encryption key producing an encrypted encryption key;
generating an encrypted data payload comprising the encrypted encryption key and the encrypted memory sub-system log data; and
sending the encrypted data payload to the host system in response to the request received from the host system.

2. The system of claim 1, further comprising a two-way communication port, and the request is received via the two-way communication port.

3. The system of claim 1, further comprising a host interface to facilitate communication with the host system, wherein the request corresponds to one or more commands received from the host system via the host interface.

4. The system of claim 1, further comprising a key store to store the asymmetric encryption key.

5. The system of claim 1, further comprising a logging component to generate and store the log data.

6. The system of claim 1, wherein the memory sub-system log data comprises statistical information related to operation of a memory sub-system.

7. The system of claim 1, wherein generating the symmetric encryption key is based on Advanced Encryption Standard (AES).

8. The system of claim 1, wherein generating the symmetric encryption key comprises:
generating, by a random number generator, a random number; and
deriving the symmetric encryption key from the random number using a key derivation function.

9. The system of claim 1, wherein the asymmetric encryption key is generated using an Rivest-Shamir-Adleman (RSA) encryption algorithm.

10. The system of claim 1, wherein the asymmetric encryption key is a public key of an encryption key pair, the encryption key pair comprising the public key and a private key.

11. A method comprising:
receiving, from a host system, a request for memory sub-system log data;
in response to receiving the request, generating, by at least one processor of a memory sub-system controller, a symmetric encryption key for encrypting the requested memory-sub-system log data;
encrypting, by the at least one processor of the memory sub-system controller, the requested memory sub-system log data using the symmetric encryption key, the encrypting of the requested memory sub-system producing encrypted memory sub-system log data;
encrypting, by the at least one processor of the memory sub-system controller, the symmetric encryption key using an asymmetric encryption key, the encrypting of the symmetric encryption key producing an encrypted encryption key;
generating, by the at least one processor of the memory sub-system controller, an encrypted data payload comprising the encrypted encryption key and the encrypted memory sub-system log data; and
sending the encrypted data payload to the host system in response to the request received from the host system.

12. The method of claim 11, wherein the request is received from the host system via a communication port of the memory sub-system controller.

13. The method of claim 1, wherein the request corresponds to one or more commands received from the host system via a host interface of the memory sub-system controller.

14. The method of claim 11, further comprising accessing the asymmetric encryption key from a key store of the memory sub-system controller.

15. The method of claim 11, further comprising accessing the requested memory sub-system log data from a logger component of the memory sub-system controller, the memory sub-system log data comprising statistical information related to operation of a memory sub-system.

16. The method of claim 11, wherein:
the generating of the symmetric encryption key comprises generating the encryption key based on the Advanced Encryption Standard (AES); and
the asymmetric encryption key is pre-generated using an Rivest-Shamir-Adleman (RSA) encryption algorithm.

17. The method of claim 11, wherein the generating of the symmetric encryption key comprises:
generating, by a random number generator, a random number; and
deriving the symmetric encryption key from the random number using a key derivation function.

18. The method of claim 11, wherein:
the asymmetric encryption key is a public key;
the method further comprises:
sending the encrypted data payload to a secure server, the secure server having a private key corresponding to the public key;
decrypting, at the secure server, the encrypted encryption key using the private key, the decrypting of the encrypted encryption key producing the symmetric encryption key; and
decrypting the encrypted log data using the symmetric encryption key.

19. A non-transitory computer-readable storage medium comprising instructions that, when executed by a processing device, configures the processing device to perform operations comprising:
receiving, from a host system, a request for memory sub-system log data;
determining whether a size of the requested memory sub-system log data satisfies a threshold size condition;
based on determining the size of the requested memory sub-system log data satisfies the threshold size condition, generating a symmetric encryption key for encrypting the requested memory-sub-system log data;
encrypting the requested memory sub-system log data using the symmetric encryption key, the encrypting of the requested memory sub-system producing encrypted memory sub-system log data;
encrypting the symmetric encryption key using an asymmetric encryption key, the encrypting of the encryption key producing an encrypted encryption key;
generating an encrypted data payload comprising the encrypted encryption key and the encrypted memory sub-system log data; and
sending the encrypted data payload to the host system in response to the request received from the host system.

20. The non-transitory computer-readable storage medium of claim 19, wherein the instructions further configured the processing device to perform operations:
encrypting the requested memory sub-system using the asymmetric encryption key based on determining the size of the requested memory sub-system log data does not satisfy the threshold size condition; and
sending a response to the request to the host system, the response including the encrypted memory sub-system.
